(19) United States
(12) Patent Application Publication
(10) Pub. No.: US 2009/0051804 A1
(43) Pub. Date: Feb. 26, 2009

(54) IMAGING DEVICE

(75) Inventors: Hiroshi NOMURA, Saitama (JP); Atsumi KANEKO, Tokyo (JP); Isao OKUDA, Saitama (JP); Eijiroh TADA, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/191,578

(22) Filed: Aug. 14, 2008

(30) Foreign Application Priority Data
Aug. 22, 2007 (JP) 2007-216020

(51) Int. Cl. H04N 5/225

(52) U.S. Cl. 348/344; 348/E05.024

(57) ABSTRACT

An imaging device includes a housing including a first photographing aperture and a second photographing aperture which are open toward opposite directions; at least one image pickup device and an image processing circuit for processing signals output from the image pickup device, the image pickup device and the image processing circuit being positioned within the housing and lie in a plane including the first photographing aperture; a first optical system having a bent optical path for forming an image of light incident from the first photographing aperture on an imaging surface of the image pickup device, the bent optical path being defined by a plurality of reflecting surfaces of the first optical system; and a second optical system having a linear optical path for forming an image of light incident from the second photographing aperture on the imaging surface of the image pickup device.

### BACKGROUND OF THE INVENTION

1. Field of the Invention

The present invention relates to an imaging device, more specifically to an imaging device incorporated in a mobile electronic device such as a mobile phone.

2. Description of the Related Art

In recent years, mobile electronic devices such as mobile phones with an inward-facing camera (sub-camera) in addition to an outward-facing camera (main camera) have been in widespread use. The outward-facing camera is used to capture still images or video clips of ordinary subjects while the inward-facing camera is used to capture still images or video clips of the user himself/herself for, e.g., video conferencing. In this type of mobile electronic device, it has been desired to prevent the device from increasing in size and production cost due to the installation of more than one camera to the body of the mobile electronic device. For instance, Japanese Unexamined Patent Publication 2007-116361 has proposed an imaging device which is configured to be capable of switching between outward-facing image capturing and inward-facing image capturing via a linking-up of a reflector and a light shielding member which are installed in a single housing.

Since the reflector and the light shielding member need to be linked with each other in the imaging device disclosed in the aforementioned publication, the imaging device tends to become complicated. In addition, a space needs to be secured for allowing the reflector and the light shielding member to move, which makes it difficult to slim the body of the imaging device.

### SUMMARY OF THE INVENTION

The present invention provides a simple and compact imaging device which has the function of capturing images of objects at opposite locations and is suitable for use as a dual-facing camera unit such as an outward-inward facing camera unit incorporated in a mobile electronic device.

According to an aspect of the present invention, an imaging device is provided, including a housing including a first photographing aperture and a second photographing aperture which are open toward opposite directions; at least one image pickup device and an image processing circuit for processing signals output from the image pickup device, the image pickup device and the image processing circuit being positioned within the housing and lie in a plane including the first photographing aperture; a first optical system having a bent optical path for forming an image of light incident from the first photographing aperture on an imaging surface of the image pickup device, the bent optical path being defined by a plurality of reflecting surfaces of the first optical system; and a second optical system having a linear optical path for forming an image of light incident from the second photographing aperture on the imaging surface of the image pickup device.

It is desirable for the second optical system to be adjacent to an optical path of the first optical system which extends along an exit optical axis of the first optical system, the exit optical axis extending toward the image pickup device from one of the plurality of reflecting surfaces of the first optical system which is closest to the image pickup device. The exit optical axis of the first optical system and an optical axis of the second optical system are substantially parallel to each other.

It is desirable for a first imaging area on the imaging surface utilized by the first optical system and a second imaging area on the imaging surface utilized by the second optical system not to overlap each other.

It is desirable for the imaging device to include an inclined light-shielding wall which is positioned in the housing between the first optical system and the second optical system and inclined to recede from an optical axis of the second optical system in a direction away from the imaging surface of the image pickup device.

It is desirable for the first optical system to include a prism, installed at a position adjacent to the second optical system, for reflecting an incident light toward the image pickup device by a reflecting surface of the prism, the inclined light-shielding wall being positioned along an outer surface of the prism.

It is desirable for the second optical system to be positioned adjacent to the reflecting surface of the prism, the inclined light-shielding wall being positioned along the reflecting surface of the prism.

It is desirable for the reflecting surface of the prism and the inclined light-shielding wall to face each other with a slight gap therebetween.

It is desirable for the prism to include an inclined side surface which is non-orthogonal to the reflecting surface of the prism, wherein the second optical system is adjacent to the inclined side surface of the prism, and the inclined light-shielding wall is positioned along the inclined side surface of the prism.

It is desirable for a surface of the inclined light-shielding wall which faces an optical path of the second optical system to include a series of light blocking lines.

It is desirable for the inclined light-shielding wall to be formed integral with the housing.

It is desirable for the first optical system to form the image of the light incident from the first photographing aperture on a first portion of the imaging surface of the image pickup device, and for the second optical system to form the image of the light incident from the second photographing aperture on a second portion of the imaging surface of the image pickup device.

It is desirable for the image pickup device to include two separate image pickup devices arranged at different positions at which the image of the light incident from the first photographing aperture and the image of the light incident from the second photographing aperture are formed, respectively.

It is desirable for the imaging device to include a cover board fixed to an opening formed in the housing, the image pickup device and the image processing circuit being mounted on the cover board.

It is desirable for the first optical system to include two prisms which include the plurality of reflecting surfaces.

It is desirable for each of the two prisms to include a right-angle prism.

It is desirable for the imaging device to be incorporated in a mobile electronic device, wherein the mobile electronic device includes an outward-facing camera window and an inward-facing camera window, the imaging device being installed in the mobile electronic device with the first photographing aperture and the second photographing aperture facing the outward-facing camera window and the inward-facing camera window, respectively.

In an embodiment, an imaging unit is provided, including a housing including a first photographing aperture and a second photographing aperture which are formed on opposite sides of the housing, respectively; a cover board fixed to the housing to cover an opening formed in the housing, the first photographing aperture and the opening being formed side by side on one of the opposite sides of the housing; at least one image pickup device and an image processing circuit mounted on the cover board, the image processing circuit processing signals output from the image pickup device; a first optical system having a bent optical path for forming an image of light incident from the first photographing aperture on an imaging surface of the image pickup device, the bent optical path being formed by a plurality of reflecting surfaces of the first optical system; and a second optical system having a linear optical path for forming an image of light incident from the second photographing aperture on the imaging surface of the image pickup device.

According to the present invention, a simple and compact imaging device which has the function of capturing images of objects at opposite locations is achieved. In addition, the inclined light-shielding wall makes it possible to prevent leakage of light from between the first optical system and the second optical system in an effective manner.

The present disclosure relates to subject matter contained in Japanese Patent Application No. 2007-216020 (filed on Aug. 22, 2007) which is expressly incorporated herein by reference in its entirety.

### BRIEF DESCRIPTION OF THE DRAWINGS

The present invention will be described below in detail with reference to the accompanying drawings in which:

FIG. 1 is a perspective view of a folding type of mobile phone in which an imaging unit according to the present invention is incorporated, showing a fully open state (unfolded state) of the mobile phone;

FIG. 2 is a perspective view of the mobile phone shown in FIG. 1, viewed from the other side of the mobile phone shown in FIG. 1;

FIG. 3 is a perspective view of a first embodiment of the imaging unit, showing the outward appearance thereof, and also showing the interior of the imaging unit to show an imaging optical system included in the imaging unit by dashed lines;

FIG. 4 is a perspective view of the imaging unit, viewed from the other side (front side) of the imaging unit shown in FIG. 3;

FIG. 5 is a cross sectional view taken along the V-V line shown in FIG. 3;

FIG. 6 is a simplified front view of the cover board fixed to the housing of the first embodiment of the imaging unit, showing the layout of the electronic circuit parts contained on the cover board;

FIG. 7 is a block diagram of the electronic circuit parts contained on the cover board shown in FIG. 6, showing the connection for control between the electronic circuit parts;

FIG. 8 is a front elevational view of a second embodiment of the imaging unit with the cover board removed from the housing;

FIG. 9 is a cross sectional view taken along the IX-IX line shown in FIG. 8;

FIG. 10 is a cross sectional view taken along the X-X line shown in FIG. 8;

FIG. 11 is a perspective view of a second prism which serves as an element of the main optical system of the second embodiment of the imaging device and a sub-photographing lens group which constitutes the sub-optical system of the second embodiment of the imaging device;

FIG. 12 is a simplified front view of the cover board fixed to the housing of the second embodiment of the imaging unit, showing the layout of the electronic circuit parts contained on the cover board;

FIG. 13 is a block diagram of the electronic circuit parts contained on the cover board shown in FIG. 12, showing the connection for control between the electronic circuit parts;

FIG. 14 is a block diagram of the electronic circuit parts contained on the cover board shown in FIG. 12, showing the connection for control between the electronic circuit parts; and

FIG. 15 is a view similar to that of FIG. 10, showing another embodiment of the inclined light-shielding member shown in FIG. 10, wherein a series of light blocking lines formed on the inclined light-shielding member shown in FIG. 15 are different in shape from that formed on the inclined light-shielding member shown in FIG. 10.

### DESCRIPTION OF THE PREFERRED EMBODIMENTS

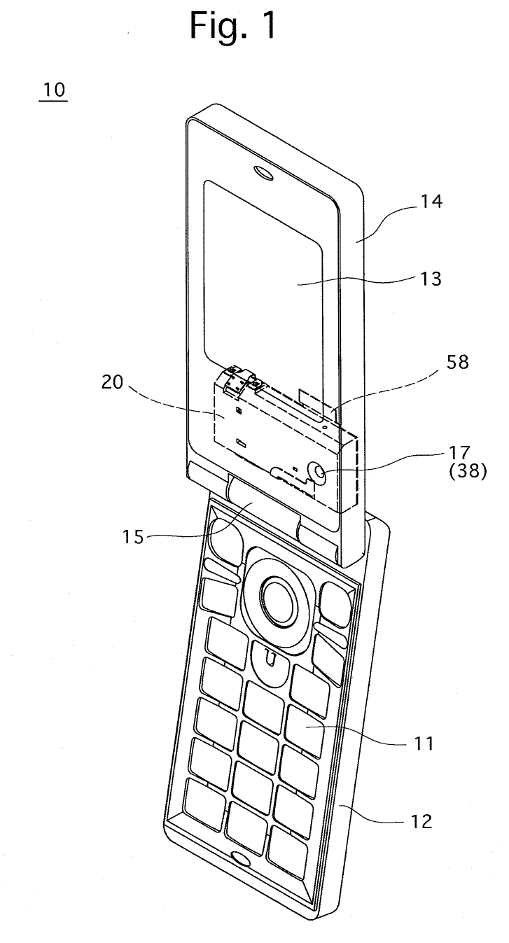

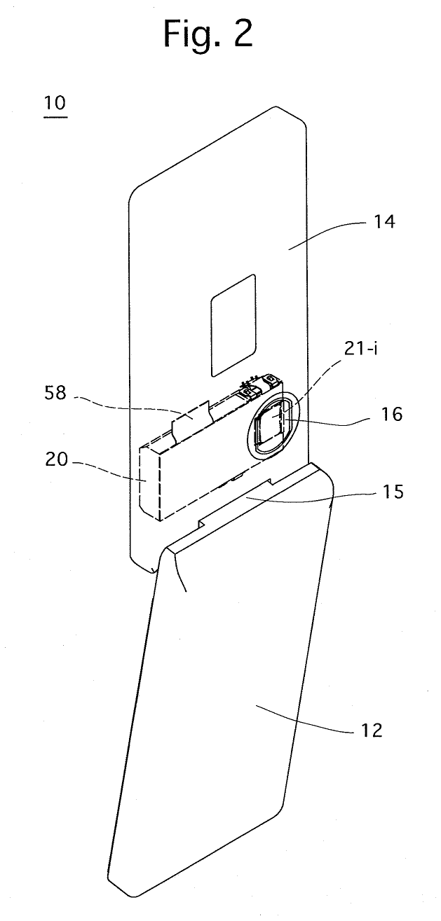

A mobile phone (cellular phone) 10 shown in FIGS. 1 and 2 which is equipped with an outward-facing camera (main camera) and an inward-facing camera (sub-camera) is a folding type which is provided with a foldable housing including an operational portion 12 and a display portion 14, and is further provided between the operational portion 12 and the display portion 14 with a hinge 15. The operational portion 12 and the display portion 14 are hingedly connected with each other via the hinge 15 to be allowed to rotate relative to each other about the axis of the hinge 15 so that the mobile phone 10 can change between an operating state (fully open state/ unfolded state) shown in FIGS. 1 and 2, in which the operational portion 12 and the display portion 14 are fully opened, and a folded state (not shown) in which the mobile phone 10 is folded so that the operational portion 12 and the display portion 14 overlay each other. The operational portion 12 is provided with a plurality of operational keys 11 such as numerical keys and other keys such as function keys, and the display portion 14 is provided with a liquid crystal display (LCD) 13, serving as a display device. The display portion 14 is provided, on the back thereof (outer surface of the display portion 14 that is exposed whether the mobile phone is a folded state or a fully open state) in the vicinity of the hinge 15, with an outward-facing camera window 16. On the other hand, the display portion 14 is provided, in the vicinity of the hinge 15 on the front side (the liquid crystal display 13 side) of the display portion 14 that faces the operational portion 12 when the mobile phone 10 is in the folded state, with an inward-facing camera window 17. The mobile phone 10 is provided, in the display portion 14 between the outward-facing camera window 16 and the inward-facing camera window 17, with an imaging unit (imaging module) 20. In the following descriptions of the imaging unit 20, the lengthwise direction of the liquid crystal display 13, the widthwise direction of the liquid crystal display 13 and the direction of the thickness of the display portion 14 are referred to as the longitudinal direction, the lateral direction and the depthwise direction, respectively. In addition, one side and the other side of the imaging unit 20 which face the outward-facing camera window 16 and the inward-facing camera window 17 are defined as the front side and the back side of the imaging unit 20, respectively.

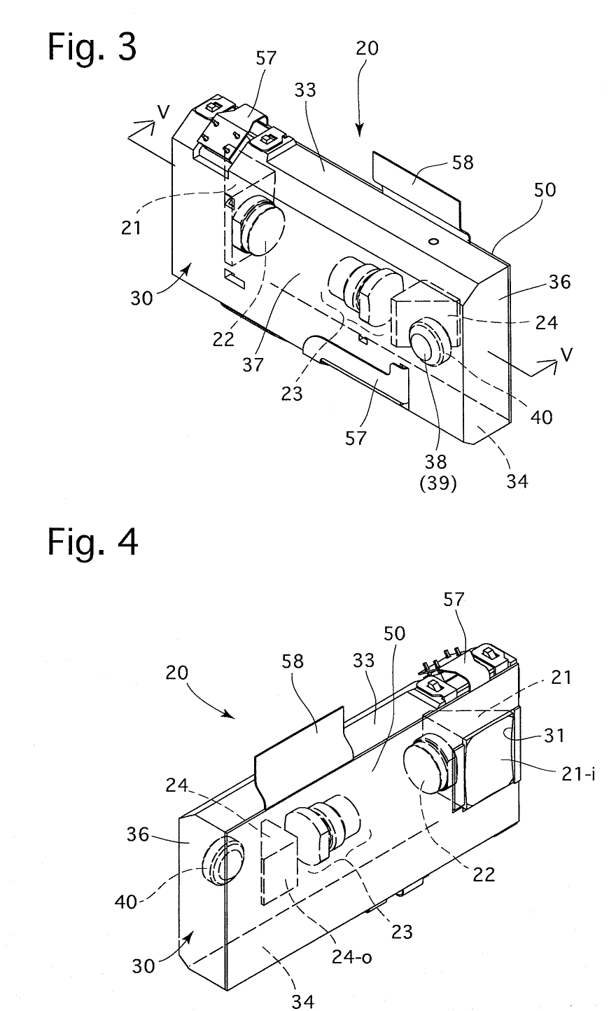

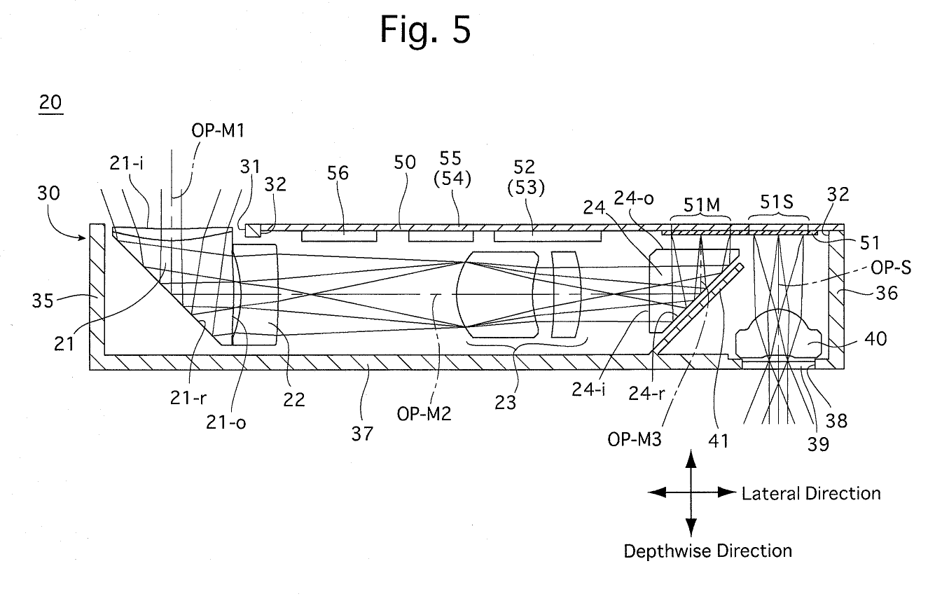

The imaging unit 20 is provided with a housing 30 formed as a box-shaped body which is elongated in the lateral direction. As shown in FIG. 5, the housing 30 is provided, on the front side thereof that faces the outward-facing camera window 16, with a front opening (first photographing aperture) 31 and a substrate-fixing opening 32, and is further provided, around the front opening 31 and the substrate-fixing opening 32, with a pair of lateral walls 33 and 34 (see FIGS. 3 and 4) and a pair of longitudinal walls 35 and 36. Additionally, the housing 30 is provided, in the back thereof that faces the inward-facing camera window 17, with a back wall 37 which closes the back of the housing 30. The pair of lateral walls 33 and 34 are substantially parallel to each other and the pair of longitudinal walls 35 and 36 are also substantially parallel to each other. The back wall 37 is positioned to face the front opening 31 and the substrate-fixing opening 32 and substantially orthogonal to both the pair of lateral walls 33 and 34 and the pair of longitudinal walls 35 and 36. The back wall 37 is provided with a back opening (second photographing aperture) 38 which is formed through the back wall 37 in the depthwise direction so that the inside and the outside of the housing 30 are communicatively connected to each other through the back opening 38. The imaging unit 20 is provided with a transparent member 39 which is fitted in the back opening 38 to be fixed thereto for protective and dust preventive purposes. In the lateral direction of the housing 30, the front opening 31 is formed at a position adjacent to the longitudinal wall 35, and the back opening 38 is formed at a position adjacent to the longitudinal wall 36.

The imaging unit 20 is provided, in the housing 30 at a position adjacent to the longitudinal wall 35, with a first prism 21. Additionally, the imaging unit 20 is provided, in the housing 30 in the vicinity of the back opening 38 on the opposite side of the position of the back opening 38 from the longitudinal wall 36 side in the lateral direction, with a second prism 24. The first prism 21 is a right-angle prism which is provided with an incident surface 21-i, an exit surface 21-o and a reflection surface 21-r. The first prism 21 reflects light incident from the incident surface 21-i at a substantially right angle toward the exit surface 21-o by the reflection surface 21-r. The second prism 24 is a right-angle prism which is provided with an incident surface 24-i, an exit surface 24-o and a reflection surface 24-r. The second prism 24 reflects light incident on the incident surface 24-i at a substantially right angle toward the exit surface 24-o by the reflection surface 24-r. The first prism 21 is installed in the housing 30 with the incident surface 21-i being exposed outwardly through the front opening 31 and with the exit surface 21-o being orientated toward the longitudinal wall 36. The second prism 24 is installed in the housing 30 with the incident surface 24-i being orientated toward the exit surface 21-o of the first prism 21 and with the exit surface 24-o being orientated toward the substrate-fixing opening 32.

The imaging unit 20 is further provided in the housing 30 between the first prism 21 and the second prism 24 with a first lens group 22 and a second lens group 23. The first lens group 22 is installed to face the exit surface 21-o of the first prism 21 and the second lens group 23 is installed to face the incident surface 24-i of the second prism 24.

The first prism 21, the first lens group 22, the second lens group 23 and the second prism 24 constitute a main optical system (first optical system) for capturing images through the outward-facing camera window 16. Upon light being incident on the main optical system, light from the object side is incident on the incident surface 21-i along an incident optical axis OP-M1, as shown in FIG. 5. The incident optical axis OP-M1 extends in the depthwise direction. The first prism 21 reflects the incident light by the reflection surface 21-r at a substantially right angle, and the light thus reflected by the reflection surface 21-r exits from the first prism 21 through the exit surface 21-o and travels through the first lens group 22 and the second lens group 23 along an intermediate optical axis OP-M2 that extends in the lateral direction to be incident on the incident surface 24-i of the second prism 24. The second prism 24 reflects the incident light toward the object side by the reflection surface 24-r at a substantially right angle so that the light thus reflected by the reflection surface 24-r exits from the second prism 24 through the exit surface 24-o along an exit optical axis OP-M3 that is substantially parallel to the incident optical axis OP-M1. Accordingly, the main optical system is configured as an optical system including the incident optical axis OP-M1, the intermediate optical axis OP-M2 and the exit optical axis OP-M3, which constitute an optical axis bent in a substantially U-shape.

The first lens group 22 and the second lens group 23 are each supported to be movable along the intermediate optical axis OP-M2 (in the lateral direction) in the housing 30 and driven forward and reverse along the intermediate optical axis OP-M2 by at least one lens drive motor (not shown), respectively. The main optical system is a zoom optical system in which the focal length is varied by moving the first lens group 22 and the second lens group 23 relative to each other along the intermediate optical axis OP-M2 in a predetermined moving manner. Additionally, a focusing operation can be carried out by moving either the first lens group 22 or the second lens group 23 along the intermediate optical axis OP-M2. Although it is optional as to which of the first lens group 22 and the second lens group 23 is used as a focusing lens group, the second lens group 23 is used as a focusing lens group in the present embodiment of the imaging unit 20.

The imaging unit 20 is further provided between the second prism 24 and the longitudinal wall 36 in the housing 30 with a sub-photographing lens group 40 which constitutes a sub-optical system (second optical system) of the inward-facing camera. The sub-optical axis OP-S of the sub-photographing lens group 40 extends linearly in the depthwise direction of the housing 30 and is substantially parallel to the exit optical axis OP-M3 of the main optical system. Light which is incident on the sub-photographing lens group 40 through the back opening 38 exits from said sub-photographing lens group 40 toward the substrate-fixing opening 32 along the sub-optical axis OP-S.

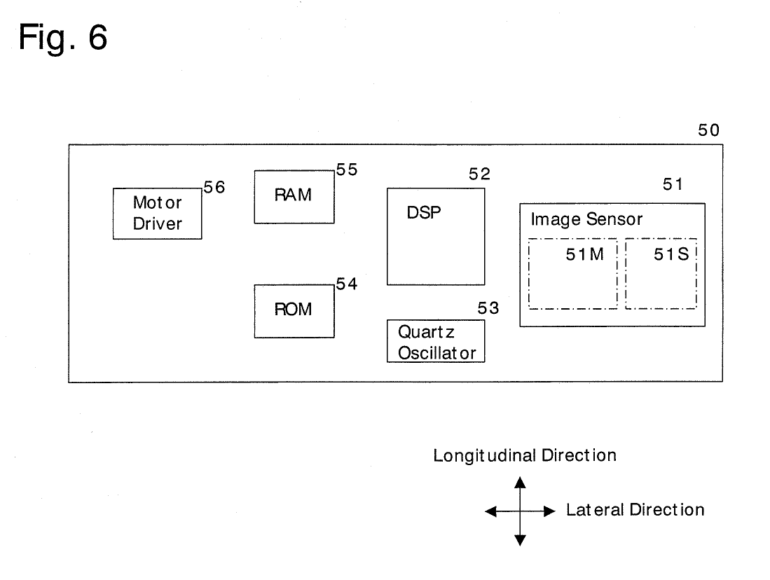

The imaging unit 20 is completed by fixing a cover board 50 to the housing 30 so as to close the substrate-fixing opening 32 after the above described elements are installed to the housing 30. As shown in FIG. 6, the cover board 50 is provided with electronic circuit parts such as an image sensor (image pickup device) 51, a digital signal processor (hereinafter referred to as DSP) 52, a quartz oscillator 53, a read-only memory (hereinafter referred to as ROM) 54, a random-access memory (hereinafter referred to as RAM) 55 and a motor driver 56, which are all mounted on a rectangular substrate elongated in the lateral direction of the housing 30.

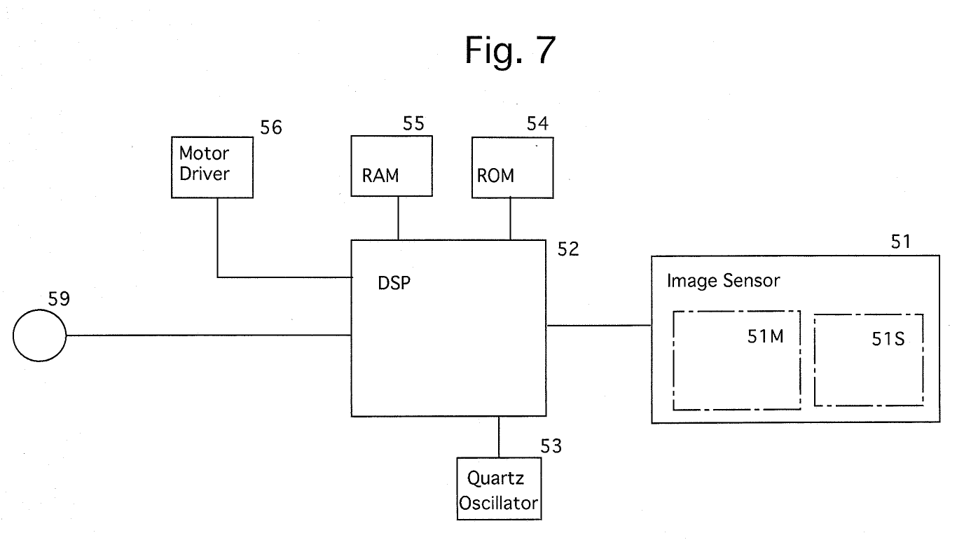

FIG. 7 shows the connection for control between electronic circuit parts contained on the cover board 50. The image sensor 51 is a conventional type such as a CCD or CMOS image sensor that converts light incident on the imaging surface (light-receiving surface) thereof into an electrical signal to output this signal. In live view mode in which live images (live preview) are displayed on the liquid crystal display 13, the signal from the usage area of the image sensor 51 is sequentially read out therefrom by control of the DSP 52 to be processed by the DSP 52 therein in order to be generated as a signal (YUV signal) capable of being visually indicated by display elements of the liquid crystal display 13. When a photograph is taken to capture a still image, all the pixel signals (pixel data) are read out of the image sensor 51 in accordance with a control signal output from the DSP 52 to be processed by the DSP 52 therein, compressed in a predetermined format such as JPEG by the DSP 52, and output from the DSP 52 as an image signal capable of being stored into an external memory (e.g., a removable memory card) via an external interface 59 (see FIG. 7). The DSP 52 also controls the operations of the aforementioned lens drive motors for driving the first lens group 22 and the second lens group 23 along the intermediate optical axis OP-M2 via the motor driver 56. A program for operating the DSP 52 is stored in the ROM 54. Upon startup of the power of the mobile phone 10, the DSP 52 reads in this program from the ROM 54 to perform a series of startup processes, and processes the signal output from the image sensor 51 to output object images (live preview), which visually informs the user that the mobile phone 10 has entered a ready-to-photograph state. The RAM 55 is used as a temporary storage in order for the DSP 52 to process the image signal input from the image sensor 51. The quartz oscillator 53 outputs a timing signal with a preset clock speed.

As shown in FIG. 5, upon the cover board 50 being fixed to the housing 30 so as to close the substrate-fixing opening 32, the imaging surface (light receiving surface) of the image sensor 51 is positioned to face the exit surface 24-o of the second prism 24. In other words, the image sensor 51 is positioned on the exit optical axis OP-M3 of the main optical system and the sub-optical axis OP-S of the sub-optical system. The main optical system forms an image of the incident light, which is incident on the main optical system through the front opening 31, onto a first area (first imaging area) 51M on the imaging surface of the image sensor 51, and the sub-optical system forms an image of the incident light, which is incident on the sub-optical system through the back opening 38, onto a second area (second imaging area) 51S on the imaging surface of the image sensor 51. When the cover board 50 is fixed to the housing 30, the fixing position of the cover board 50 relative to the housing 30 is finely adjusted so that an object image formed through the main optical system and an object image formed through the sub-optical system are precisely formed on the first area 51M and the second area 51S of the imaging surface of the image sensor 51, respectively. The cover board 50 is fixed to the housing 30 by, for example, adhesive.

When the cover board 50 is fixed to the housing 30, a motor drive flexible PCB (printed circuit board) 57 (see FIG. 3) which extends from the cover board 50 is connected to terminals of the aforementioned lens drive motors. The motor drive flexible PCB 57 is connected to the motor driver 56, so that the operation of each lens drive motor can be controlled by the motor driver 56 upon completion of the installation of the cover board 50 to the housing 30.

The imaging unit 20 in a completed state thereof after the cover board 50 and the housing 30 have been joined to each other is in the shape of a box including front and rear light incident portions (optical apertures), i.e., the front opening 31, through which the incident surface 21-i of the first prism 21 is exposed outwardly, and the back opening 38, toward which the incident surface of the sub-photographing lens group 40 faces. The imaging unit 20 is installed in the display portion 14 of the mobile phone 10 so that the incident surface 21-i of the first prism 21 (the front opening 31) is positioned immediately behind the outward-facing camera window 16 and that the incident surface of the sub-photographing lens group 40 (the back opening 38) is positioned immediately behind the inward-facing camera window 17 as shown in FIGS. 1 and 2. In this installation operation, an image-signal flexible PCB (printed circuit board) 58 which extends from the cover board 50 is connected to a control circuit (not shown) provided in the mobile phone 10.

The control circuit of the mobile phone 10 sends a control signal which is input via an operating device such as the operational keys 11 to the imaging unit 20 via the image-signal flexible PCB 58. This control signal can be, e.g., a photographing-operation execution signal, a live-view (image-indication) execution signal, a zooming operation signal or a camera switching signal (photographing-mode switching signal). Upon inputting the photographing-operation execution signal, the imaging unit 20 carries out a photographing operation including the above-described focusing operation (in which the second lens group 23 is driven by the associated lens drive motor), and the imaging unit 20 sends an image signal which has been processed and formatted by the DSP 52 to be stored in memory to the control circuit via the image-signal flexible PCB 58. Upon inputting the live-view execution signal, the imaging unit 20 sends an image signal (YUV signal) for on-screen indication which has been processed by the DSP 52 to the control circuit via the flexible PCB 58. In addition, immediately after the imaging unit 20 inputs the zooming operation signal, the two lens drive motors are actuated via the motor driver 56 to change the focal length of the imaging optical system of the imaging unit 20. Additionally, power is also supplied to the imaging unit 20 via the flexible PCB 58.

The camera switching signal is for switching between an outward-facing camera mode using the main optical system and an inward-facing camera mode using the sub-optical system. In the outward-facing camera mode, signals output from the pixels in the first area 51M on the imaging surface of the image sensor 51 are used in the image processing performed in the DSP 52 when live images are displayed on the liquid crystal display 13 in the aforementioned live view mode or when images are captured. In the inward-facing camera mode, signals output from the pixels in the second area 51S on the imaging surface of the image sensor 51 are used in the image processing performed in the DSP 52 when live images are displayed on the liquid crystal display 13 in the aforementioned live view mode or when images are captured.

As described above, an imaging system of the mobile phone 10 is completed by connecting the flexible PCB 58 that extends from the imaging unit 20 to the control circuit of the mobile phone 10. In the manufacturing process of the mobile phone 10, the imaging unit 20, which includes electronic circuit parts on the cover board 50 and is assembled as a module in advance, is simply installed in the display portion 14, and accordingly, no complicated operation for installation of the imaging unit 20 is necessary; hence, the mobile phone 10 is superior in workability of assembly thereof. From a similar point of view, the mobile phone 10 is superior in maintainability if the imaging unit 20 is repaired or replaced. In addition, the load of image processing is not applied to the control circuit of the mobile phone 10 since the image signal having been processed by the DSP 52 is output from the imaging unit 20.

Additionally, in the imaging unit 20, the housing 30 that contains the image sensor 51 is provided on two sides thereof with the front opening 31 and the back opening 38 that face the outward-facing camera window 16 and the inward-facing camera window 17, respectively, and the main optical system for taking pictures through the front opening 31 and the sub-optical system for taking pictures through the back opening 38 are installed in a single housing, i.e., the housing 30. Accordingly, the imaging unit 20 is simpler in structure with less number of elements than a conventional type of imaging device in which an outward-facing camera (main camera) and an inward-facing camera (sub-camera) are installed independently, so that the production cost of the imaging unit 20 can be reduced.

The main optical system of the imaging unit 20 includes two reflecting surfaces: the reflecting surface 21-r of the first prism 21 and the reflecting surface 24-r of the second prism 24, and is configured as an optical system including the incident optical axis OP-M1, the intermediate optical axis OP-M2 and the exit optical axis OP-M3, which constitute an optical axis bent in a substantially U-shape. Additionally, the main optical system forms an object image on the image sensor 51 (the first area 51M) mounted on the cover board 50 that is fixed to the front side of the housing 30. On the other hand, the sub-optical system forms an optical path, at a position adjacent to an optical path of the main optical system which extends along the exit optical axis OP-M3, which extends linearly along the sub-optical axis OP-S that is parallel to the exit optical axis OP-M3. Similar to the main optical system, the sub-optical system forms an object image on the image sensor 51 (the second area 51S) mounted to the front side of the housing 30. Accordingly, the sub-optical system of the imaging unit 20 is arranged in a manner to overlay (coincide with) the main optical system in the lateral direction of the housing 30. In addition, electronic circuit parts such as the DSP 52 for performing image processing on the main optical system and the sub-optical system are arranged to lie in a plane in which the image sensor 51 lies (on the cover board 50). This arrangement makes it possible to make the imaging unit 20 compact in size while allowing the imaging unit 20 to be provided with both the outward-facing camera (main camera) and the inward-facing camera (sub-camera). Specifically, since the sub-optical system is disposed in a space lying on an extension of the main optical system in the lateral direction of the housing 30, and also since the image sensor 51 and the DSP 52 that are mounted on the cover board 50 to lie in the same plane thereon are shared between the main optical system and the sub-optical system, even providing the sub-optical system in the housing 30 does not increase the size of the housing 30 in the depthwise direction as compared with a comparative case where the housing 30 includes the main optical system but does not include the sub-optical system, and accordingly, a miniaturization in thickness of the imaging unit 20 is achieved.

As shown in FIG. 5, in the imaging unit 20, the housing 30 is further provided between the second prism 24 (which serves as an element of the main optical system) and the sub-photographing lens group 40 (which constitutes the sub-optical system) with an inclined light-shielding wall 41. The inclined light-shielding wall 41 projects inwardly from the back wall 37 and is inclined to approach the longitudinal wall 36 in a direction away from the back wall 37 toward the front side of the housing 30 (toward the cover board 50). In other words, the inclined light-shielding wall 41 is formed as a wall which is inclined to recede from the sub-optical axis OP-S of the sub-optical system in the lateral direction of the housing 30 while receding from the imaging surface of the image sensor 51 in the depthwise direction of the housing 30. The direction of extension of the inclined light-shielding wall 41 is substantially parallel to the reflecting surface 24-r of the second prism 24, and the inclined light-shielding wall 41 is positioned behind the reflecting surface 24-r therealong with a slight spacing between the inclined light-shielding wall 41 and the reflecting surface 24-r. The reflecting surface 24-r of the second prism 24 is a reflecting surface which totally reflects the incident light. Such a function of totally reflecting the incident light is prevented from deteriorating by the aforementioned arrangement wherein the inclined light-shielding is spaced from the reflecting surface 24-r.

The inclined light-shielding wall 41 is a light shielding member which shields light between the main optical system and the sub-optical system, and especially has the capability of shielding light from the sub-optical system that is passed through the sub-photographing lens group 40 to prevent this light from entering the main optical system. Although light does not easily leak toward the sub-optical system from the main optical system since the reflecting surface 24-r of the second prism 24 totally reflects the incident light in the present embodiment of the imaging unit 20, a leakage of light toward the sub-optical system from the main optical system is prevented from having an adverse influence on the optical performance of the sub-optical system by the light-shielding capability of the inclined light-shielding wall 41 even if such a leakage of light occurs.

As described above, the inclined light-shielding wall 41 is made as an inclined wall which is shaped to extend away from the sub-optical axis OP-S in the direction from the image sensor 51 (on which an object image is formed by the sub-optical system) toward the back opening 38 (which serves as a light incident portion). If internal reflection of light by the inclined light-shielding wall 41 is incident on the image sensor 51, this internal reflection may exert a harmful influence on the image quality, and accordingly, it is desirable to suppress the internal reflection as much as possible. Unlike the inclined light-shielding wall 41 of the present embodiment of the imaging unit 20, assuming that a light shielding wall is installed between the second prism 24 and the sub-optical system so as to be parallel to the sub-optical axis OP-S, the light shielding wall would be formed in the vicinity of the optical path of the sub-optical system due to space limitations, which makes internal reflection by the light shielding wall easy to occur. Additionally, if the light shielding wall is parallel to the sub-optical axis, internal reflection of light by the light shielding wall can easily travel toward the image sensor 51. In contrast, the inclined light shielding wall 41 of the present embodiment of the imaging unit 20 is formed so as to be inclined in a direction away from the sub-optical axis OP-S, thus not being too close to the optical path of the sub-optical system and preventing internal reflection from occurring. Additionally, the direction of inclination of the inclined light shielding wall 41 makes the light which is reflected thereby difficult to travel toward the image sensor 51. Therefore, in the sub-optical system, the harmful internal reflection of light that is reflected by the inclined light shielding wall 41 to travel toward the image sensor 51 is not easily produced, which makes it possible to achieve excellent optical performance. In addition, since the inclined light shielding wall 41 is arranged along the reflecting surface 24-r of the second prism 24, the inclined light shielding wall 41 excels in space utilization, allowing the inclined light shielding wall 41 to be positioned sufficiently away from the sub-optical system with no need to increase the size of the housing 30. Although the inclined light shielding wall 41 is formed integral with the back wall 37 of the housing 30 in the present embodiment of the imaging unit 20, the inclined light shielding wall 41 can be formed to project from a different portion of the housing 30 or formed not as an integral part of the housing 30.

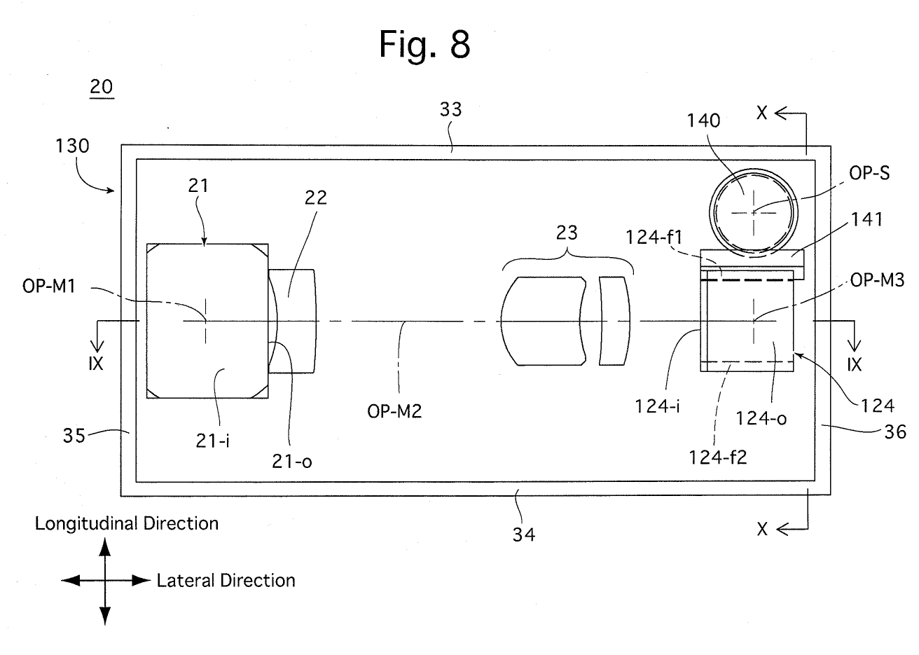

A second embodiment of the imaging unit will be hereinafter discussed with reference to FIG. 8 and others figures thereafter. Elements of the second embodiment of the imaging unit which correspond to those of the first embodiment of the imaging unit are designated by the same reference numerals, and only other elements of the second embodiment of the imaging unit that are different from those of the first embodiment of the imaging unit will be discussed hereinafter.

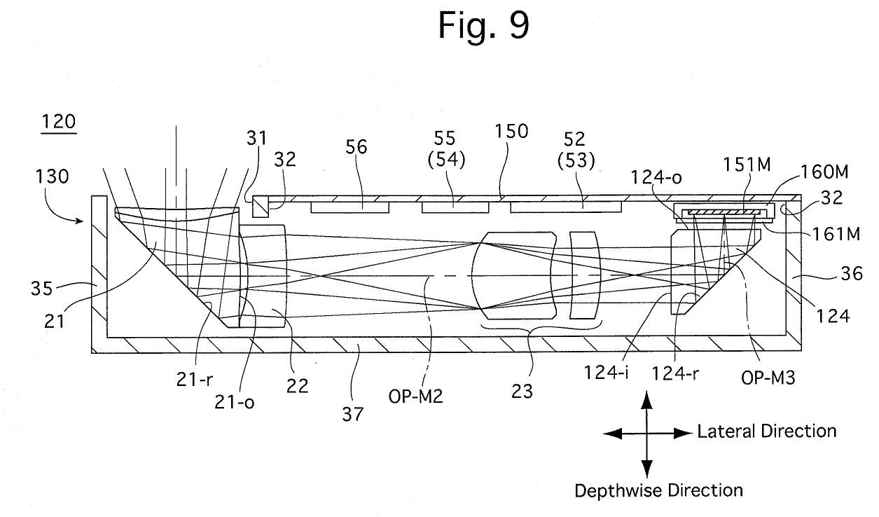

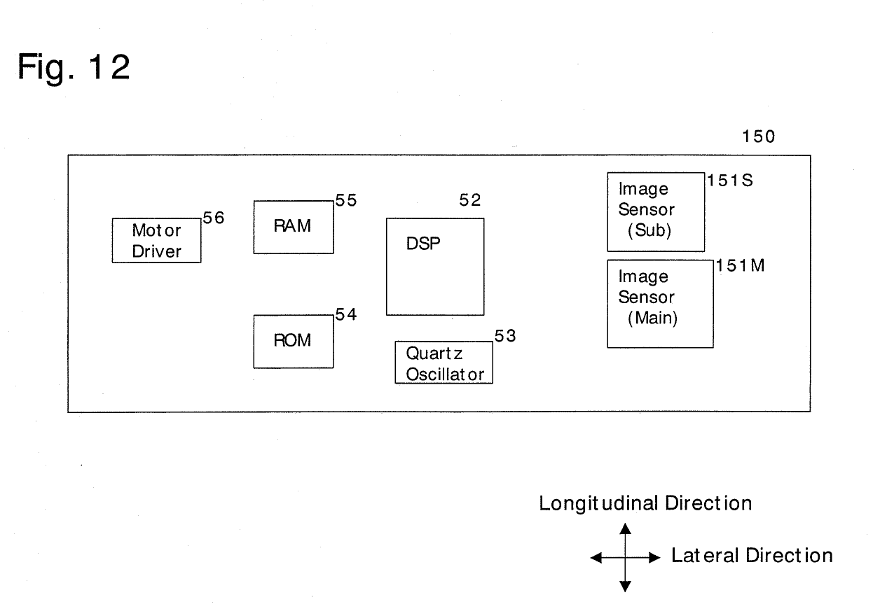

FIGS. 8, 9 and 10 show a front elevational view, a transverse sectional view and a longitudinal sectional view of the imaging unit 120, respectively. The front elevational view of FIG. 8 shows the interior of a housing 130 with a cover board 150 being removed. As can be seen from these drawings, in the imaging unit 120, a sub-photographing lens group 140 which constitutes the sub-optical system of the imaging unit 120 is positioned in the space between a second prism 124 and the lateral wall 33, not in the space between the second prism 124 and the longitudinal wall 36 in the housing 130. Namely, the sub-optical system of the imaging unit 120 is arranged in a manner to overlay the main optical system in the longitudinal direction of the housing 130, not in the lateral direction of the housing 130. Correspondingly, a back opening (second photographing aperture) 138 of the back wall 37 of the housing 130 and a transparent member 139 fitted in the back opening 138 to be fixed thereto are formed at a position closer to the lateral wall 33 than a plane which includes the optical axes OP-M1, OP-M2 and the OP-M3 of the main optical system. Additionally, as shown in FIG. 12, an image sensor (image pickup device) 151M for the main optical system and an image sensor (image pickup device) 151S for the sub-optical system are provided separately and arranged adjacent to each other in the longitudinal direction of the housing 130 on the cover board 150. The image sensors 151M and 151S are held by sensor holders 160M and 160S, respectively. The fronts of the image sensors 151M and 151S are covered by cover glasses 161M and 161S, respectively.

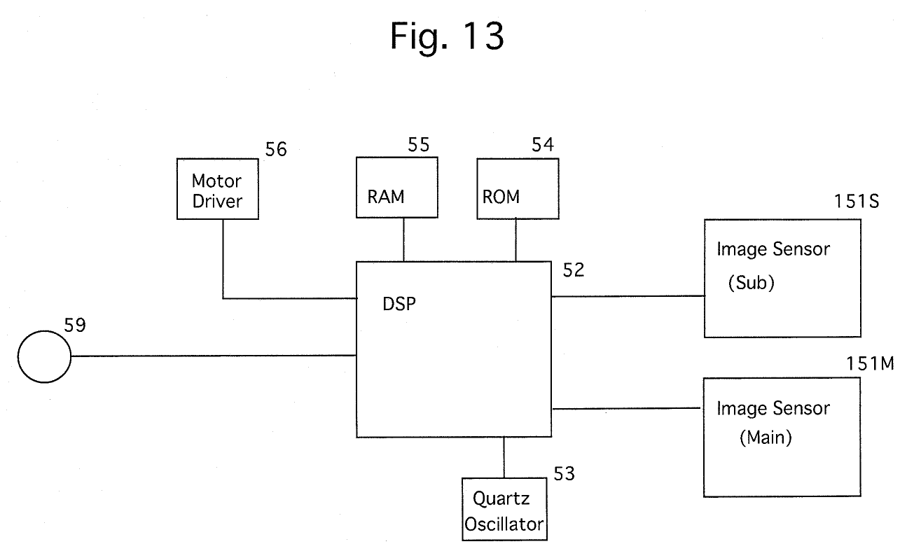

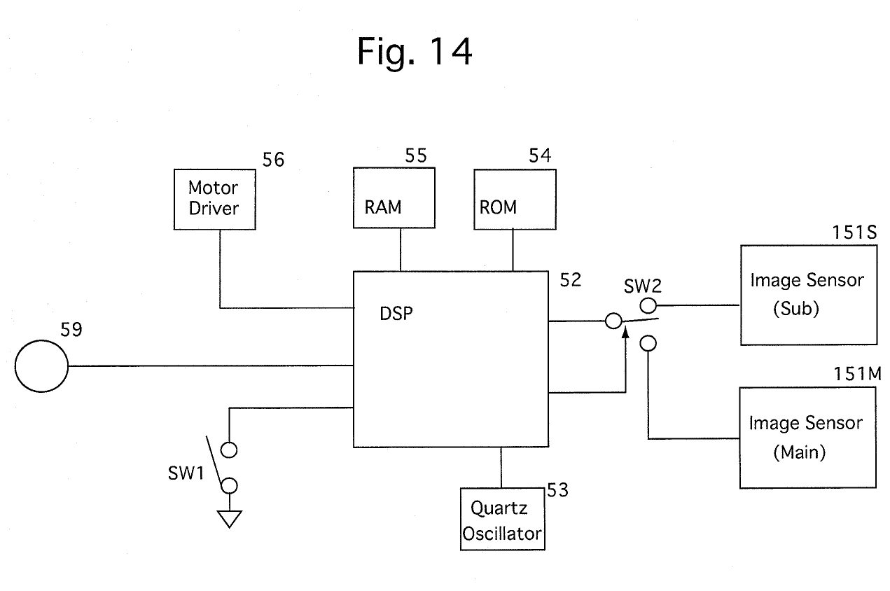

FIG. 13 shows an embodiment of the connection for control between the electronic circuit parts mounted on the cover board 150. A program performed in the DSP 52 switches between the image sensor 151M for the main optical system and the image sensor 151S for the sub-optical system. FIG. 14 shows another embodiment of the connection for control between the electronic circuit parts mounted on the cover board 150. In this embodiment, the imaging unit 120 is provided with a mechanical select switch SW1. In accordance with the operation of the mechanical switch SW1, a sensor change-over switch SW2 installed between the DSP 52 and each of the two image sensors 151M and 151S is actuated to select between the two image sensors 151M and 151S for use in sending image signals to the DSP 52.

Similar to the first embodiment of the imaging unit 20, in the second embodiment of the imaging unit 120, the main optical system is configured as an optical system including the incident optical axis OP-M1, the intermediate optical axis OP-M2 and the exit optical axis OP-M3, which constitute an optical axis bent in a substantially U-shape, while the sub-optical system forms an optical path which extends linearly along the sub-optical axis OP-S that is parallel to the exit optical axis OP-M3 at a position adjacent to an optical path of the main optical system which extends along the exit optical axis OP-M3. Additionally, the main optical system and the sub-optical system form object images on the imaging surfaces of the image sensors 151M and 151S, respectively, that are supported on a common plane (on the cover board 150) on the front side of the housing 130. Electronic circuit parts such as the DSP 52 for performing image processing are also arranged on the cover board 150 to lie in a plane in which the image sensors 151M and 151S lie. Due to this arrangement, a miniaturization in thickness of the imaging unit 120 is achieved even though the imaging unit 120 incorporates both the outward-facing camera (main camera) and the inward-facing camera (sub-camera).

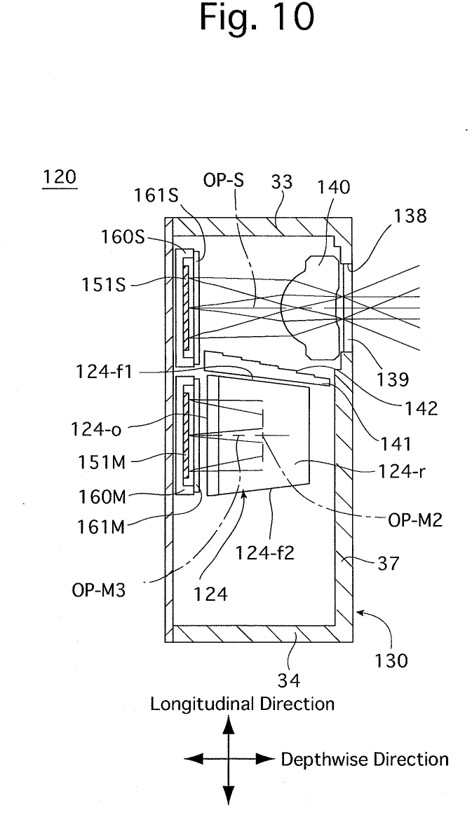

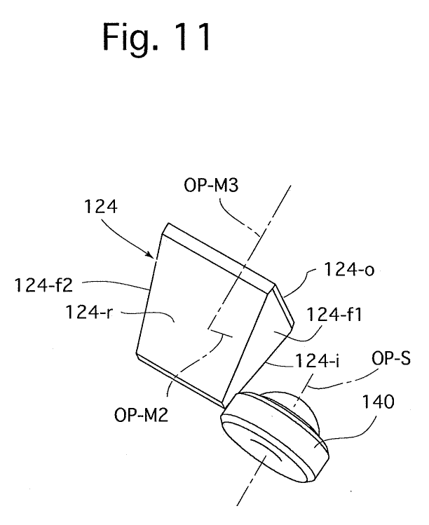

The imaging unit 120 is provided between an optical path of the sub-optical system and the second prism 124 with an inclined light-shielding wall 141 which prevents leakage of light from between the main optical system and the sub-optical system. As shown in FIGS. 10 and 11, the second prism 124 is provided with an incident surface 124-i, a reflecting surface 124-r and an exit surface 124-o, and opposite side surfaces of the second prism 124 between which the incident surface 124-i, the reflecting surface 124-r and the exit surface 124-o are positioned are formed as inclined side surfaces 124-f1 and 124-f2, respectively, which are non-parallel to each of the incident surface 124-i, the reflecting surface 124-r and the exit surface 124-o (not parallel to a plane including the intermediate optical axis OP-M2 and the exit optical axis OP-M3). The inclined side surfaces 124-f1 and 124-f2 are formed so that the distance therebetween increases in a direction toward the image sensor 151M from the back wall 37 side along the exit optical axis OP-M3. The inclined light-shielding wall 141 is arranged along the inclined side surface 124-f1 of the second prism 124. The inclined light-shielding wall 141 is inclined to recede from the sub-optical axis OP-S of the sub-optical system along the longitudinal direction of the housing 130 as receding away from the imaging surface of the image sensor 151S in the depthwise direction of the housing 130. Therefore, similar to the inclined light-shielding wall 41 of the first embodiment of the imaging unit 20, internal reflection of light which may exert an adverse influence on the image-capturing capability of the sub-optical system does not easily occur at the inclined light-shielding wall 141.

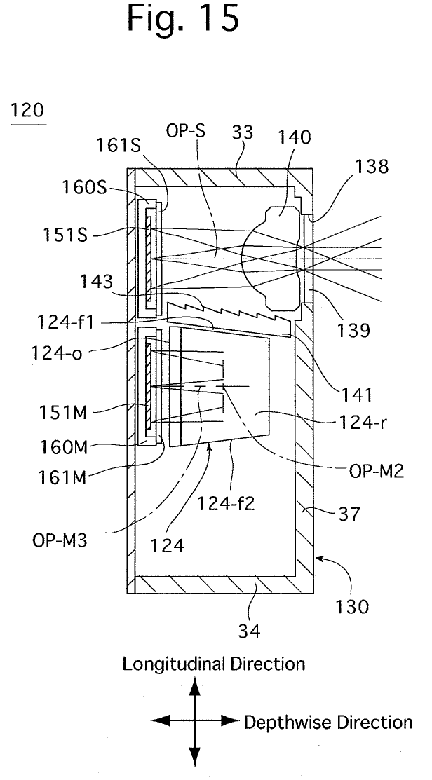

As shown in FIG. 10, the inclined light-shielding wall 141 is provided, on a surface thereof which faces the optical path of the sub-optical system, with a series of light blocking lines 142 having a step-shaped cross section to prevent the internal reflection of light from occurring more efficiently. A manner of forming such a series of light blocking lines on the inclined light-shielding wall 141 is not limited solely to this particular manner; the inclined light-shielding wall 141 can be provided thereon with a series of light blocking lines 143 each of which has a wedge-like cross section as shown in FIG. 15. Additionally, a coating or a plush fabric can be adopted as an internal reflection preventive device in addition to the series of light blocking lines 142 or 143. This kind of internal reflection preventive device can also be applied to the inclined light-shielding wall 41 of the first embodiment of the imaging unit 20.

As can be seen from the inclined light-shielding wall 141 of this embodiment of the imaging unit 120, the inclined light-shielding wall, which is installed between the main optical system and the sub-optical system, can be installed along a surface of a prism of the main optical system other than a reflecting surface of the prism. In this case, it is desirable that an inclined surface such as the inclined side surface 124-f1 of the second prism 124 be formed on an optical element (prism) serving as an element of the main optical system adjacent to the inclined light-shielding wall within a range not deteriorating the optical performance of the optical element. This makes it possible to prevent the optical element and the inclined light-shielding wall from interfering with each other and to improve the space utilization by reducing the clearance between the optical element and the inclined light-shielding wall; consequently, the imaging unit can be prevented from increasing in size. Similar to the inclined light-shielding wall 41 in the first embodiment of the imaging unit 20, the inclined light-shielding wall 141 can be formed either integrally with or independent of the housing 130.

As can be understood from each of the above described embodiments, according to the present invention, miniaturization of the imaging device, especially a reduction in thickness of the imaging device in the depthwise direction of the housing (forward-rearward direction/direction of an optical axis of incident light) is achieved. Moreover, a light shielding structure suitable for this slimmed-down imaging device is achieved since the inclined light-shielding wall has a simple and space-saving structure with no moving parts, and also since it is possible to prevent leakage of light from between the main optical system and the sub-optical system while preventing undesirable internal reflection of light from occurring.

Although the present invention has been discussed with reference to the above described embodiments and the accompanied drawings, the present invention is not limited solely to these particular embodiments; making various modifications to the imaging unit is possible without departing from the spirit or essential character thereof.

For instance, the main optical system provided in each of the above described first and second embodiments of the imaging units includes the first lens group 22 and the second lens group 23 that are movable along the intermediate optical axis OP-M2 to be capable of performing an optical zooming operation; however, the present invention can also be applied to an imaging device with no optical zoom function.

Additionally, the imaging unit according to the present invention can be incorporated in not only mobile phones but also any other types of mobile devices such as digital cameras (still-video cameras), digital camcorders (motion-video cameras), personal digital assistants (PDSs), personal computers and mobile computers.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An imaging device comprising:
a housing including a first photographing aperture and a second photographing aperture which are open toward opposite directions;
at least one image pickup device and an image processing circuit for processing signals output from said image pickup device, said image pickup device and said image processing circuit being positioned within said housing and lie in a plane including said first photographing aperture;
a first optical system having a bent optical path for forming an image of light incident from said first photographing aperture on an imaging surface of said image pickup device, said bent optical path being defined by a plurality of reflecting surfaces of said first optical system; and
a second optical system having a linear optical path for forming an image of light incident from said second photographing aperture on said imaging surface of said image pickup device.

2. The imaging device according to claim 1, wherein said second optical system is adjacent to an optical path of said first optical system which extends along an exit optical axis of said first optical system, said exit optical axis extending toward said image pickup device from one of said plurality of reflecting surfaces of said first optical system which is closest to said image pickup device, and
wherein said exit optical axis of said first optical system and an optical axis of said second optical system are substantially parallel to each other.

3. The imaging device according to claim 1, wherein a first imaging area on said imaging surface utilized by said first optical system and a second imaging area on said imaging surface utilized by said second optical system do not overlap each other.

4. The imaging device according to claim 2, further comprising an inclined light-shielding wall which is positioned in said housing between said first optical system and said second optical system and inclined to recede from an optical axis of said second optical system in a direction away from said imaging surface of said image pickup device.

5. The imaging device according to claim 4, wherein said first optical system comprises a prism, installed at a position adjacent to said second optical system, for reflecting an incident light toward said image pickup device by a reflecting surface of said prism, said inclined light-shielding wall being positioned along an outer surface of said prism.

6. The imaging device according to claim 5, wherein said second optical system is positioned adjacent to said reflecting surface of said prism, said inclined light-shielding wall being positioned along said reflecting surface of said prism.

7. The imaging device according to claim 6, wherein said reflecting surface of said prism and said inclined light-shielding wall face each other with a slight gap therebetween.

8. The imaging device according to claim 5, wherein said prism comprises an inclined side surface which is non-orthogonal to said reflecting surface of said prism,
wherein said second optical system is adjacent to said inclined side surface of said prism, and
wherein said inclined light-shielding wall is positioned along said inclined side surface of said prism.

9. The imaging device according to claim 4, wherein a surface of said inclined light-shielding wall which faces an optical path of said second optical system comprises a series of light blocking lines.

10. The imaging device according to claim 4, wherein said inclined light-shielding wall is formed integral with said housing.

11. The imaging device according to claim 1, wherein said first optical system forms said image of said light incident from said first photographing aperture on a first portion of said imaging surface of said image pickup device, and
wherein said second optical system forms said image of said light incident from said second photographing aperture on a second portion of said imaging surface of said image pickup device.

12. The imaging device according to claim 1, wherein said image pickup device comprises two separate image pickup devices arranged at different positions at which said image of said light incident from said first photographing aperture and said image of said light incident from said second photographing aperture are formed, respectively.

13. The imaging device according to claim 1, further comprising a cover board fixed to an opening formed in said housing, said image pickup device and said image processing circuit being mounted on said cover board.

14. The imaging device according to claim 1, wherein said first optical system comprises two prisms which include said plurality of reflecting surfaces.

15. The imaging device according to claim 14, wherein each of said two prisms comprises a right-angle prism.

16. The imaging device according to claim 1, wherein said imaging device is incorporated in a mobile electronic device,
wherein said mobile electronic device comprises an outward-facing camera window and an inward-facing camera window, said imaging device being installed in said mobile electronic device with said first photographing aperture and said second photographing aperture facing said outward-facing camera window and said inward-facing camera window, respectively.

17. An imaging unit comprising:
a housing including a first photographing aperture and a second photographing aperture which are formed on opposite sides of said housing, respectively;
a cover board fixed to said housing to cover an opening formed in said housing, said first photographing aperture and said opening being formed side by side on one of said opposite sides of said housing;
at least one image pickup device and an image processing circuit, mounted on said cover board, said image processing circuit processing signals output from said image pickup device;
a first optical system having a bent optical path for forming an image of light incident from said first photographing aperture on an imaging surface of said image pickup device, said bent optical path being formed by a plurality of reflecting surfaces of said first optical system; and
a second optical system having a linear optical path for forming an image of light incident from said second photographing aperture on said imaging surface of said image pickup device.
